(19) United States
(12) Patent Application Publication
(10) Pub. No.: US 2023/0382063 A1
(43) Pub. Date: Nov. 30, 2023

(54) THERMOPLASTIC COMPOSITE BROADGOOD AND DEPOSITION MEANS

(71) Applicant: Spirit AeroSystems, Inc., Wichita, KS (US)

(72) Inventors: W. Robert Nelson, Wichita, KS (US); Audra Morgan, Wichita, KS (US)

(21) Appl. No.: 18/319,170

(22) Filed: May 17, 2023

Related U.S. Application Data
(60) Provisional application No. 63/345,083, filed on May 24, 2022.

(51) Int. Cl. B29C 70/54

(52) U.S. Cl. CPC B29C 70/543; B29K 2101/12

(57) ABSTRACT

Embodiments of the present invention relate to a thermoplastic composite broadgood and a means of depositing a thermoplastic composite broadgood onto a mold. The broadgood may comprise of a plurality of separate, parallel strips of thermoplastic prepreg attached together by a plurality of delamination arresting elements. The broadgood may be deposited onto a mold by means of an apparatus comprising a plurality of flexible metal straps, each strap being configured to be heated. The straps may temporarily adhere to the broadgood when heated, thereby allowing the broadgood to be moved by means of the apparatus.

### BACKGROUND

### Field

Embodiments of the present invention relate to a thermoplastic composite broadgood and a means of depositing a thermoplastic composite broadgood onto a mold.

### Related Art

Thermoplastic composite materials have long been of interest to aerostructures manufacturers because they offer several potential advantages when compared to more conventional thermoset composite materials. Unlike thermosets, thermoplastic materials can be re-melted after solidification, thus facilitating recycling of both manufacturing waste and completed aerostructures at the end of their life cycles. This capability can reduce environmental externalities relating to both disposal of waste and manufacture of new material. The same re-meltable characteristic of thermoplastics that facilitates recycling also enables thermoplastic components to be joined into assemblies by welding rather than relying exclusively on fasteners, thereby potentially reducing an assembly's weight as well as simplifying its manufacture. The ability to re-melt a thermoplastic component may also lead to more repair options, both during the manufacturing stage and in service. There are significant financial and environmental benefits associated with reducing manufacturing scrap and keeping existing structures in service as long as possible.

Unfortunately, the promise of thermoplastic materials in the aerospace industry has not been realized to date. This is due, in part, to the limited deposition rates that have been achieved with thermoplastic composite materials. For large-area, contoured components, automated fiber placement (AFP) has been the only option available for thermoplastic deposition. Hand layup of individual strips of unidirectional composite tape is not practical, and AFP deposition, while feasible, is a slow process, particularly when depositing thermoplastic materials.

Broadgood materials such as woven fabrics and non-crimp fabrics are currently being used in some thermoset composite applications, enabling higher deposition rates than would be possible with AFP. In theory, thermoplastic composite deposition rates could likewise be increased through the use of broadgood materials. Indeed, some thermoplastic broadgood materials are commercially available today, such as fabrics impregnated throughout with thermoplastic resin. However, these materials are not suitable for hand layup in the manner of their thermoset counterparts due to a lack of “tack” and drapability at temperatures tolerated by human workers. At room temperature, such thermoplastic materials are in a “glassy,” semi-crystalline, or otherwise rigid state. It is only after the application of heat that most existing thermoplastic broadgood materials becomes drapable (i.e., able to conform to the shape of a contoured tool) and exhibit the ability to stick or “tack” to previous laid plies. However, simply heating these existing broadgoods prior to deposition is not a satisfactory solution. The melting, softening, and processing temperatures of high performance thermoplastic materials used in aerospace applications typically exceed 300 degrees Celsius, which is impractical and unsafe to maintain over a large area in the vicinity of human workers.

Deposition of composite broadgoods via automated means has persisted as a problem for manufacturers. While some advancements have been made in the art of automating the layup of thermoset composite broadgoods, as disclosed in U.S. Pat. No. 8,763,665 (“Wampler”) and German Patent DE102012017593B4 (“Kreimeyer”) among others, broadgood layup automation has not achieved industry acceptance even in the realm of thermosets. Additional challenges must be overcome to enable successful automation of the deposition of thermoplastic composite broadgoods.

In addition, industry acceptance of thermoplastic composite broadgoods has been hampered by the limited material options available. Thus, a need exists for new thermoplastic composite broadgood material forms suitable for aerospace industry conditions (e.g., possessing superior mechanical performance) and adapted for large-scale manufacturability (e.g., exhibiting drapability at room temperature). A need also exists for processes by which such new materials may be deposited and devices by which such deposition processes may be automated.

### SUMMARY

The present invention solves the above-described problems and provides a distinct advance in the art of thermoplastic composite manufacture. One aspect of the present invention relates to a thermoplastic composite broadgood or sheet material. The broadgood material may comprise a plurality of structural strips of thermoplastic material, each reinforced with continuous unidirectional reinforcement fibers (i.e., thermoplastic prepreg). The structural strips may be aligned parallel to one another. Each structural strip of thermoplastic prepreg may be separate from adjacent strips in that the thermoplastic resin of any one strip is not directly fused to the thermoplastic resin of any adjacent strip. The broadgood material may comprise a plurality of delamination arresting elements that may be positioned at perpendicular or oblique angles with respect to the structural strips. The delamination arresting elements may be comprised of a thermoplastic resin different than the thermoplastic resin comprising the structural strips. The delamination arresting elements may function to bind the structural strips together during handling of the broadgood material, and may further function to arrest delamination in a laminate composed of multiple layers of the broadgood material.

Another aspect of the present invention relates to an apparatus suitable for depositing a thermoplastic composite broadgood material onto a mold. The apparatus may comprise a plurality of flexible metal straps. The straps may be held in tension by a frame. The apparatus may be configured to be positioned by a manipulator, such that the straps of the apparatus may be brought into contact with a thermoplastic composite broadgood material positioned at a first location. The apparatus may further comprise a power supply configured to pass electrical current through the straps of the apparatus, which may cause the straps to heat. The straps may be configured to induce “tack” or temporary adhesion between the thermoplastic composite broadgood material and the straps when heated. The apparatus may be configured to be repositioned by the manipulator, moving the thermoplastic composite broadgood material to a second location wherein the thermoplastic composite broadgood material is brought into contact with and conformed to a mold. The straps may be configured to induce a reduction in “tack” between the thermoplastic composite broadgood material and the straps when allowed to cool.

Another aspect of the present invention relates to a method of manufacturing a thermoplastic composite broadgood material. The method may comprise arranging a plurality of structural strips parallel to one another in a first direction. Each structural strip may comprise a plurality of continuous unidirectional reinforcement fibers bound together by a thermoplastic resin (i.e., a thermoplastic prepreg). The thermoplastic resin of each structural strip may be separate from and not directly fused to the thermoplastic resin of any adjacent structural strip. The method may further comprise arranging a plurality of delamination arresting elements oriented at perpendicular or oblique angles with respect to the structural strips. The delamination arresting elements may comprise a thermoplastic resin different from the thermoplastic resin of the structural strips. The method may further comprise attaching at least some of the delamination arresting elements to at least some of the structural strips.

Another aspect of the present invention relates to a method of depositing a thermoplastic composite broadgood material onto a mold. The method may comprise bringing a plurality of metal straps into contact with the thermoplastic composite broadgood material. The method may further comprise causing the metal straps to heat, thereby causing the thermoplastic composite broadgood material to “tack” or temporarily adhere to the straps. The method may further comprise moving the straps, along with the thermoplastic composite broadgood material, to a mold. The method may further comprise maintaining the straps in a heated state to cause the thermoplastic composite broadgood material to “tack” to the mold or to a previously deposited thermoplastic composite broadgood material. The method may further comprise discontinuing the heating of the straps, such that the straps cool, thereby reducing the amount of “tack” between the straps and the thermoplastic composite broadgood material.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### BRIEF DESCRIPTION OF THE DRAWING FIGURES

Embodiments of the present invention are described in detail below with reference to the attached drawing figures, wherein:

FIG. 1 is an illustration of a woven broadgood in a planar condition that may be processed in accordance with an embodiment of the present invention.

FIG. 2 is a perspective view of the woven broadgood of FIG. 1 in a conformed condition.

FIG. 3 is an illustration of a thermoplastic composite broadgood according to an embodiment of the present invention.

FIG. 4 is an illustration of a thermoplastic composite broadgood according to another embodiment of the present invention.

FIG. 5 is an illustration of a thermoplastic composite broadgood according to still another embodiment of the present invention.

FIG. 6 is a perspective view of an apparatus for depositing a thermoplastic composite broadgood in accordance with an embodiment of the present invention.

FIG. 7 is a schematic representation of electrical circuits associated with the apparatus of FIG. 6.

FIG. 8 is a perspective view of a cell for applying a thermoplastic composite broadgood to a mold in accordance with embodiments of the present invention.

FIG. 9 is a perspective view of the cell of FIG. 8 shown during the process of thermoplastic composite broadgood deposition.

FIG. 10 is a perspective view of an alternative cell for depositing a thermoplastic composite broadgood in accordance with an embodiment of the present invention.

FIG. 11 is a flow chart depicting steps in a method of manufacturing a thermoplastic composite broadgood sheet in accordance with an embodiment of the present invention.

FIG. 12 is a flow chart depicting steps in a method of manufacturing a thermoplastic composite component from thermoplastic composite broadgood material in accordance with an embodiment of the present invention.

### DETAILED DESCRIPTION

The following detailed description makes reference to accompanying drawings that illustrate specific embodiments of the present invention. Separate references to “an embodiment” or “one embodiment” do not necessarily refer to the same embodiment, though they may. The specific embodiments illustrated and/or described in detail in this disclosure are included to enable those skilled in the art to practice the invention. Other embodiments and variations will be apparent to those skilled in the art and may be substituted without departing from the scope of the present invention. Therefore, the detailed description that follows should not be construed in a limiting sense.

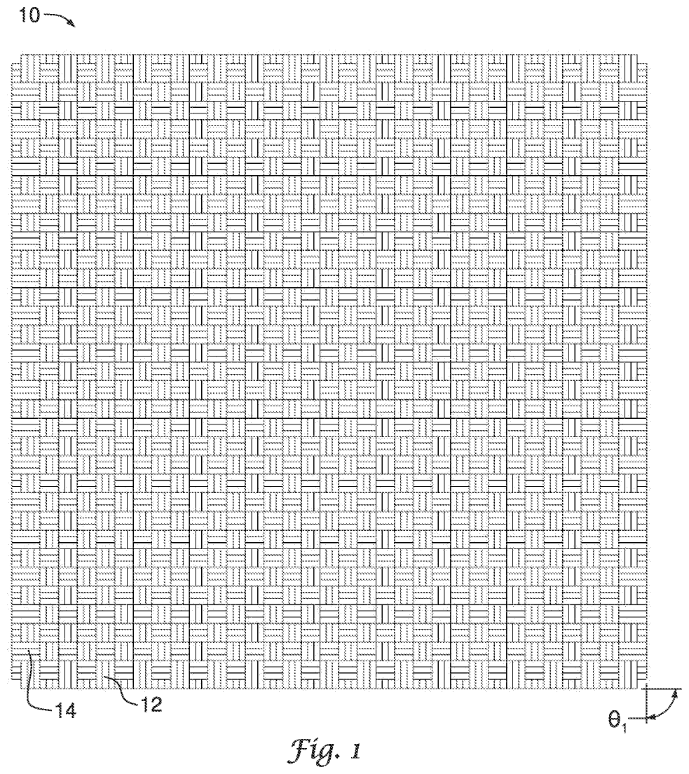

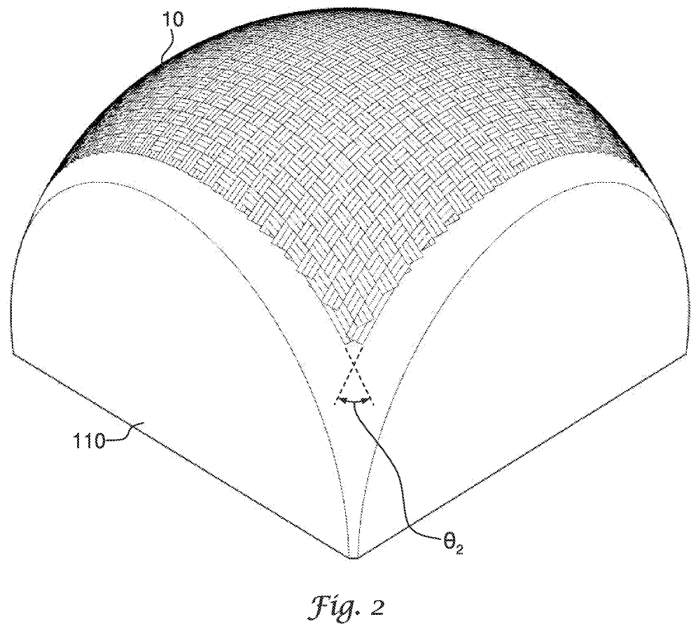

Referring now to the drawings, wherein like reference numerals designate identical or corresponding parts throughout the several views, FIG. 1 illustrates a woven broadgood sheet 10 composed of warp elements 12 and weft elements 14, shown in its original planar form. The angle θ₁ between the warp elements 12 and the weft elements 14 is approximately 90 degrees in a planar condition. FIG. 2 illustrates the same broadgood sheet 10 when conformed to a compound contour tool surface. The angle θ₂ between the warp elements 12 and the weft elements 14 in the conformed condition illustrated is approximately 54 degrees. The change in angle that must occur during the transformation of a planar broadgood sheet into a compound contoured 3D shell is known as trellising. If trellising is not allowed to occur as a broadgood sheet is conformed to a compound contour, the result will be excess material in certain areas manifesting as wrinkles. Therefore, it is an object of the present invention to provide a broadgood sheet material capable of readily trellising (or otherwise conforming to a compound contour) at room temperature and without the need to put the warp elements 12 or weft elements 14 in tension, thereby facilitating deposition and, in particular, deposition by automated means.

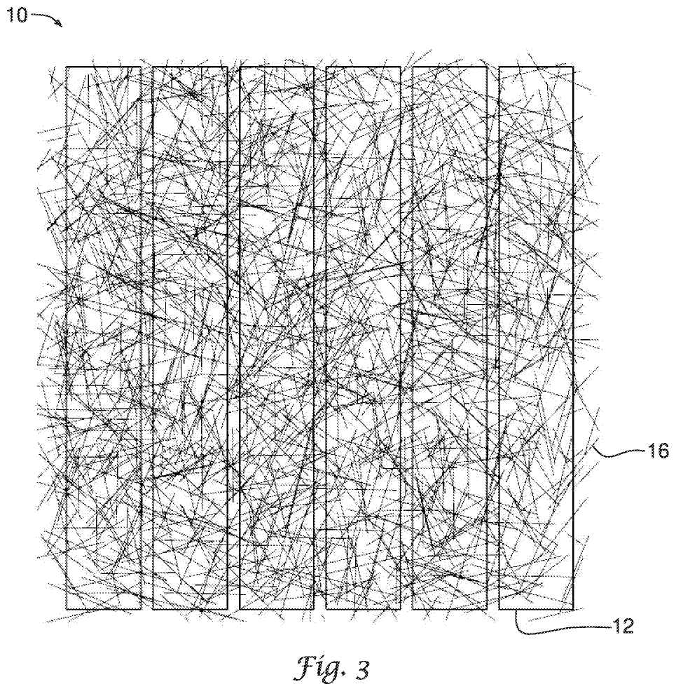

It is a further object of the present invention to provide a broadgood sheet material having enhanced structural properties. Woven materials as illustrated in FIG. 1 are known to have certain damage tolerance advantages, and may tend to be more resistant to delamination of plies, when compared to unidirectional materials. However, this comes at the expense of somewhat reduced mechanical performance as a result of the periodic undulation of fibers resulting from the over and under weave pattern. FIG. 3 illustrates a sheet 10 according to an embodiment of the present invention, suitable for use in the manufacture of a thermoplastic composite component. An example of a thermoplastic composite component is a portion of an airplane fuselage or wing where at least the outer structure is composed of multiple layers of thermoplastic composite material. The sheet 10 may comprise a plurality of parallel structural strips 12 and a plurality of delamination arresting elements 16. Each structural strip 12 may comprise a plurality of continuous unidirectional reinforcement fibers bound together by a thermoplastic resin (i.e., thermoplastic prepreg).

The reinforcement fibers of the thermoplastic prepreg structural strips 12 may comprise carbon fibers. The structural strips 12 may have a width of between 5 mm and 20 mm, and a thickness of between 0.1 mm and 0.3 mm. The thermoplastic resin of each structural strip 12 may be unattached (unfused) to the thermoplastic resin of each adjacent structural strip 12. The thermoplastic resin of the structural strip 12 may be a semi-crystalline thermoplastic resin, such as Polyetheretherketone (PEEK), Polyaryletherketone (PAEK), or Polyphenylenesulfide (PPS). The structural strips 12 may comprise thermoplastic prepreg tape that is commercially available, or they may comprise tape optimized by modifying the resin content or distribution. For example, in order to obtain the optimal resin to fiber content in the finished laminate, the resin content of the structural strips 12 may be slightly lower than what is currently commercially available so that when combined with the thermoplastic resin of the delamination arresting element, the desired resin content of the finished laminate is achieved. Each delamination arresting element 16 may be oriented at a perpendicular or oblique angle with respect to the structural strips 12.

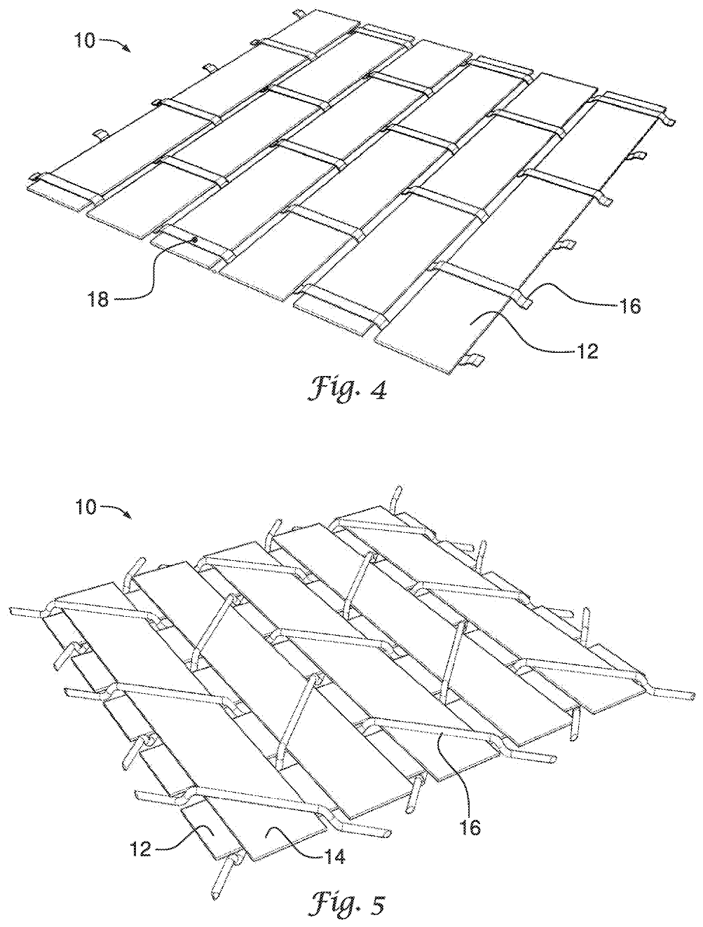

The delamination arresting elements 16 may comprise a thermoplastic resin. The thermoplastic resin of the delamination arresting elements 16 may have a lower modulus than the thermoplastic resin of the structural strips 12. The lower modulus thermoplastic resin of the delamination arresting elements 16 may increase the interlaminar fracture toughness of a laminate formed of the plurality of sheets 10 without significantly affecting the modulus of such laminate because of the low concentration of delamination arresting elements 16 in proportion to the higher modulus thermoplastic resin of the structural strips 12. The thermoplastic resin of the delamination arresting elements 16 may be miscible with the thermoplastic resin of the structural strips 12. The thermoplastic resin of the delamination arresting elements 16 may be an amorphous thermoplastic resin such as Polysulfone (PSU) or Polyetherimide (PEI). The thermoplastic resin of the delamination arresting elements 16 may be a semi-crystalline polymer that has been processed to have a lower crystallinity and/or more amorphous regions than the thermoplastic resin of the structural strips 12. The thermoplastic resin of the delamination arresting elements 16 may be a blend of semi-crystalline polymer and amorphous polymer. The thermoplastic resin of the delamination arresting elements 16 may have a lower melting temperature, lower melting range, or lower softening temperature than the melting temperature of the thermoplastic resin of the structural strips 12. The delamination arresting elements 16 may consist of a neat resin or a resin without continuous fiber reinforcement. The delamination arresting elements 16 may be in the form of randomly oriented thermoplastic fibers as illustrated in FIG. 3. Alternatively, the delamination arresting elements 16 may be in the form of periodically spaced thin ribbons of resin as illustrated in FIG. 4, or threads as illustrated in FIG. 5.

At least some of the delamination arresting elements 16 may be attached to at least some of the structural strips 12 and may serve to maintain the structural strips 12 in relative position with respect to one another, forming the sheet 10. The connection of the structural strips 12 together may be made by fusing thermoplastic resin of at least some of the delamination arresting elements 16 to thermoplastic resin of at least some of the structural strips 12, while the structural strips 12 remain unfused to adjacent structural strips 12. Alternatively or additionally, the attachment may be made by weaving the delamination arresting elements 16 over and under the structural strips 12 and relying at least in part on friction between the delamination arresting elements 16 and the structural strips 12 to maintain alignment of the structural strips 12.

Transverse structural strips 14 may optionally be included in the sheet 10. The transverse structural strips 14 may have the same composition and characteristics as the structural strips 12, but may be arranged at a perpendicular angle with respect to the structural strips 12. The transverse structural strips 14 may be connected to the structural strips 12 to form a sheet 10 by means of delamination arresting elements 16 arranged at a bias (i.e., at approximately 45 degrees) with respect to the structural strips 12 and the transverse structural strips 14, and may pass through openings formed therebetween as illustrated in FIG. 5 in the manner of a weave. The plurality of structural strips 12 may comprise a distinct layer of the sheet 10 and likewise the plurality of transverse structural strips 14 may comprise a distinct layer of the sheet 10, and the strips of each distinct layer may be confined to such layer, being unwoven with respect to the strips of the other layer. This may advantageously maintain the fibers of the structural strips 12 and the fibers of the transverse structural strips 14 in a relatively straight condition and free of the undulations that are known to result from weaving structural fibers over and under other structural fibers.

The delamination arresting elements 16 may be sized to be relatively thin in comparison to the thickness of the structural strips 12. Preferably, the delamination arresting elements 16 may be no more than fifty percent (50%) of the thickness of the structural strips 12. Still more preferably, the delamination arresting elements 16 may be no more than twenty-five percent (25%) of the thickness of the structural strips 12. The width and spacing of the delamination arresting elements 16 may preferably be sized such that after fusing of a first sheet 10 layer to a second sheet 10 layer, thermoplastic resin from the structural strips 12 or transverse structural strips 14 of the first sheet 10 layer is fused directly to thermoplastic resin from the structural strips 12 or transverse structural strips 14 of the second sheet 10 layer over at least seventy percent (70%) of the interface area between the two sheet 10 layers. More preferably, the width and spacing of the delamination arresting elements 16 may be sized such that after fusing of a first sheet 10 layer to a second sheet 10 layer, thermoplastic resin from the structural strips 12 or transverse structural strips 14 of the first sheet 10 layer is fused directly to thermoplastic resin from the structural strips 12 or transverse structural strips 14 of the second sheet 10 layer over at least ninety percent (90%) of the interface area between the two sheet 10 layers. It will be understood by those skilled in the art that in the scenario described immediately above, in those portions of the interface between the first sheet 10 layer and the second sheet 10 layer where thermoplastic resin from strips 12, 14 is not fused directly to thermoplastic resin from other strips 12, 14, such resin is instead fused to intervening thermoplastic resin from delamination arresting elements 16 having different mechanical properties selected to discouraging the propagation of delamination.

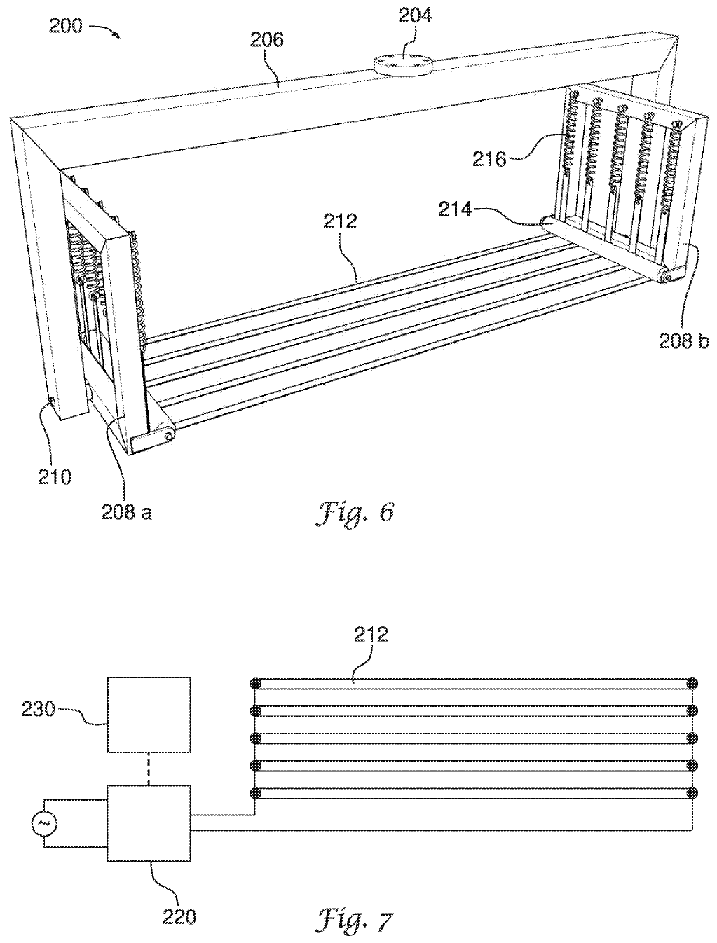

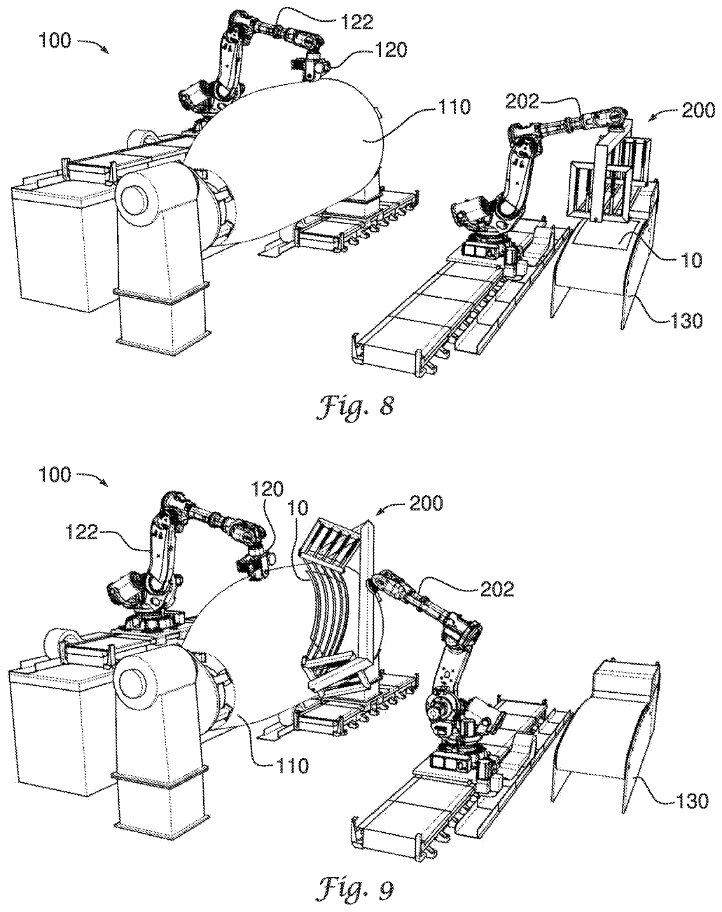

It is a further object of the present invention to provide an apparatus 200 for moving a thermoplastic composite sheet 10 and conforming it to a mold 110. The thermoplastic composite sheet 10 moved and conformed by the apparatus 200 may be a broadgood material depicted in FIG. 3, 4, or 5. Alternatively, the thermoplastic composite sheet 10 moved and conformed by apparatus 200 may be a simple “basket weave” material as depicted in FIGS. 1 and 2, or it may be any other thermoplastic broadgood material. As illustrated in FIG. 6, the apparatus 200 may comprise a plurality of flexible conductive straps 212. The straps 212 may be maintained in tension by tensioning elements 216 via rollers 214. The tensioning elements 216 and rollers 214 may be mounted to end frames 208 a, 208 b, which may in turn be pivotally coupled to opposing ends of main frame 206 via pivots 210. The pivotal coupling of the end frames 208 a, 208 b, to the main frame 206 may advantageously enhance the ability of the straps 212 to conform to a “twisted” contour, as may be encountered when applying a sheet 10 at a 45 degree orientation to a generally cylindrically shaped mold 110 as depicted in FIG. 9. Main frame 206 may be attached to manipulator 202, which may be an articulated arm robot as depicted in FIGS. 8 and 9, via attachment flange 204. As illustrated in FIG. 7, the apparatus 200 may further comprise a power supply 220 configured to apply electrical current to the straps 212, thereby causing the straps 212 to heat via the joule effect. The power supply 220 may be in electrical communication with the end frames 208 a, 208 b. The electrical current may be routed to the straps 212 via the rollers 214 or otherwise via the end frames 208 a, 208 b. The main frame 206 may be electrically insulated from at least one of the end frames 208 a, 208b. The apparatus 200 may further comprise a control system 230 configured to control the power supply 220 in accordance with process requirements.

The apparatus 200 may preferably be operated as part of a manufacturing cell 100 for the purpose of manufacturing a thermoplastic composite component. In addition to the apparatus 200, the manufacturing cell 100 may comprise a mold 110, which may preferably be a mandrel as depicted in FIGS. 8 and 9. The manufacturing cell 100 may further comprise a sheet delivery device 130 configured to present a sheet 10 to be accessed by apparatus 200 as depicted in FIG. 8, and transferred to mold 110 by apparatus 200 as depicted in FIG. 9. The sheet delivery device 130 may comprise an automated cutter for cutting discrete sheets 10 of a sheet material from a roll. Alternatively, the sheet delivery device 130 may comprise a means of assembling sheets 10 to the required shape and size from individual structural strips 12. In either case, the sheet delivery device 130 may comprise a surface accessible to the apparatus 200 from which the sheet 10 may be accessed. The accessible surface may comprise a belt configured to advance the sheet 10 from a cutting or assembly area of the sheet delivery device 130 to an area accessible to the apparatus 200. The surface may be slightly arched or convex shaped in an upward direction as depicted in FIG. 8, such that the straps 212 first make contact with the sheet 10 at the center of sheet 10 and contact is progressively expanded toward the ends of the sheet 10 as the main frame 206 of the apparatus 200 is moved toward the accessible surface of the sheet delivery device 130. This may enhance engagement between the sheet 10 and the straps 212.

It is a further object of the present invention to provide a method 300 for manufacturing a broadgood sheet material such as the broadgood sheet materials 10 illustrated in FIGS. 3, 4, and 5. At least a portion of the steps of the method 300 for manufacturing a broadgood sheet material 10 in accordance with various embodiments of the present invention are listed in FIG. 11. The steps may be performed in the order as shown in FIG. 11, or they may be performed in a different order. Further, some steps may be performed concurrently as opposed to sequentially. In addition, some steps may be omitted.

The method 300 may comprise a step of arranging a plurality of structural strips 12 parallel to one another in a first direction as depicted in block 310. Each structural strip 12 may comprise a plurality of continuous unidirectional reinforcement fibers bound together by a thermoplastic resin (i.e., thermoplastic prepreg) that is not fused to the thermoplastic resin of adjacent structural strips.

The method 300 may comprise a step of arranging a plurality of delamination arresting elements 16 oriented at perpendicular or oblique angles with respect to the structural strips as depicted in block 320. Each delamination arresting element may comprise a thermoplastic resin, which may be of a different composition than the thermoplastic resin of the structural strips.

The method 300 may comprise a step of attaching the delamination arresting elements 16 to the structural strips 12 as depicted in block 330. It will be understood by those skilled in the art that it is not necessary for every delamination arresting element 16 to be attached to every structural strip, but at least some delamination arresting elements 16 may be attached to at least some structural strips 12, such that the structural strips 12 are generally held in alignment with one another, forming a sheet 10. Delamination arresting elements 16 may be attached to the structural strips 12 only at discrete locations selected so as to allow a degree of movement between the structural strips 12 as necessary when the sheet 10 is conformed to a compound contour. Alternatively or additionally, the delamination arresting elements 16 may be made from a material having a relatively low modulus, or sized to have a relatively small cross section, thereby facilitating stretching of the delamination arresting elements 16 during the conforming of the sheet 10. The delamination arresting elements 16 may be attached to the structural strips 12 by fusing a portion of the thermoplastic resin of the delamination arresting elements 16 with a portion of the resin of the structural strips 12. Alternatively or additionally, the delamination arresting elements 16 may be attached to the structural strips by weaving the delamination arresting elements 16 under and over the structural strips as depicted in FIGS. 4 and 5.

The method 300 may further comprise a step of arranging a plurality of transverse structural strips 14 in a second direction. The method step 330 may include attaching the delamination arresting elements to the transverse structural strips 14 as well as the structural strips 12.

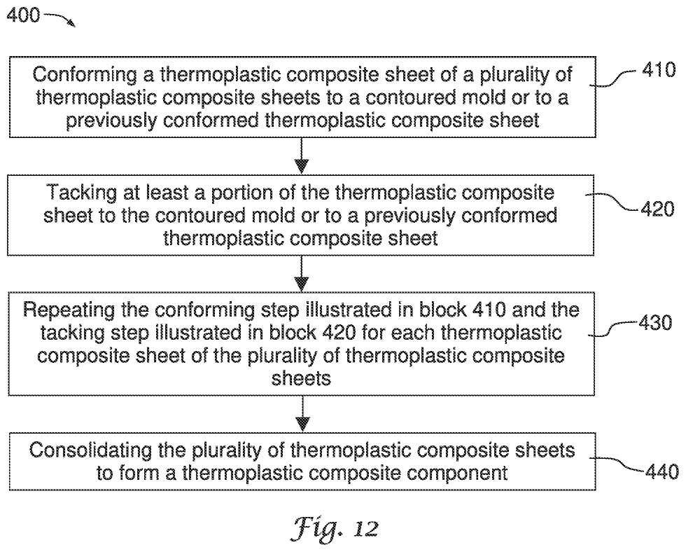

It is a further object of the present invention to provide a method 400 for manufacturing a thermoplastic composite component by depositing a broadgood sheet material onto a mold, which may optionally be implemented by means of the apparatus 200 and manufacturing cell 100. At least a portion of the steps of the method 400 for manufacturing a thermoplastic composite component in accordance with various embodiments of the present invention are listed in FIG. 12. The steps may be performed in the order as shown in FIG. 12, or they may be performed in a different order. Further, some steps may be performed concurrently as opposed to sequentially. In addition, some steps may be omitted. Still further, embodiments of the present invention may be performed using systems other than the apparatus 200 and manufacturing cell 100 without departing from the scope of the technology described herein.

The method 400 may comprise a step of conforming a thermoplastic composite sheet 10 of a plurality of thermoplastic composite sheets to a contoured mold or to a previously conformed thermoplastic composite sheet as depicted in block 410. The thermoplastic composite sheet 10 may comprise a plurality of parallel structural strips 12, and at least some of the parallel structural strips 12 may comprise continuous unidirectional fibers bound together by a thermoplastic resin that is not fused to adjacent structural strips 12. The conforming step may be performed while the thermoplastic resin of at least some of the structural strips 12 comprising the thermoplastic composite sheet is in a rigid state. The conforming step may be performed manually by picking up the thermoplastic composite sheet 10 by hand and draping it over a contoured mold surface.

Alternatively, the conforming step may be performed by an automated conforming device. The automated conforming device may comprise the apparatus 200, which may form a part of the manufacturing cell 100. The method 400 may further comprise the step of directing an electrical current through a plurality of flexible metal straps 212 of the apparatus 200 so as to create heat in the flexible metal straps 212 via the joule effect. The method 400 may further comprise the step of bringing the plurality of flexible metal straps 212 into contact with the thermoplastic composite sheet 10 so as to heat a portion of the thermoplastic resin of the thermoplastic composite sheet 10 and cause the resin of the thermoplastic composite sheet to stick or “tack” to the plurality of flexible metal straps 212. The metal straps 212 may be heated to a temperature that causes the melting or softening of the thermoplastic resin of the delamination arresting elements 16, while not melting the thermoplastic resin of the structural strips 12. The method 400 may further comprise the step of moving the plurality of flexible metal straps 212 so as to bring the thermoplastic composite sheet 10 into engagement with the contoured mold 110 or with a previously conformed thermoplastic composite sheet.

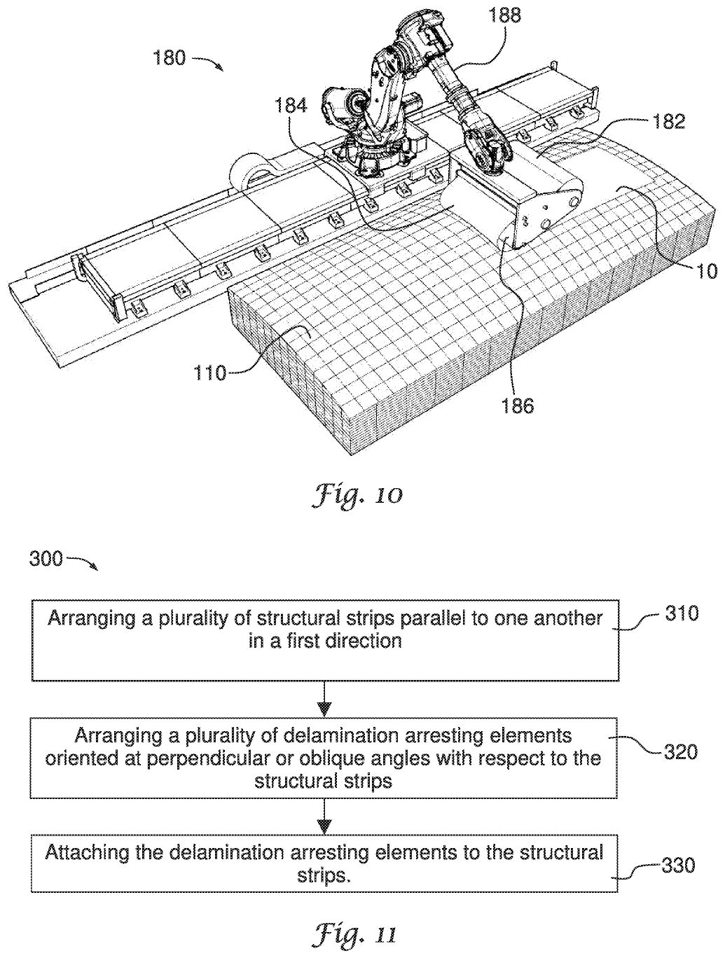

As yet another alternative, the automated conforming device may comprise a deformable roller such as the roller 186 depicted as part of the apparatus 180 illustrated in FIG. 10. The method 400 may further comprise the step of feeding thermoplastic composite sheet material from a roll 182 to the roller 186 without tensioning the thermoplastic composite sheet material, such as by providing excess material 184 ahead of roller 186. The roller 186 may conform to the contour of the mold 110 and may act to conform the initially planar thermoplastic composite sheet material to the mold 110.

The method 400 may comprise a step of tacking at least a portion of the thermoplastic composite sheet 10 to the contoured mold or to a previously conformed thermoplastic composite sheet as depicted in block 420. The tacking step may be performed manually with a tool such as a hot iron or hot air gun. A worker may heat discrete portions of the thermoplastic composite sheet 10 along with underlying portions of the contoured mold 110 or a previously conformed thermoplastic composite sheet, such that a portion of the thermoplastic resin of the thermoplastic composite sheet 10 adheres to the mold 110 or to a previously conformed thermoplastic composite sheet.

Alternatively, the tacking step 420 may be performed by an automated tacking device. The automated tacking device may be incorporated into the apparatus 200, which may form a part of the manufacturing cell 100. The method 400 may further comprise the step of maintaining the electrical current through a plurality of flexible metal straps 212 of the apparatus 200, thereby maintaining heat in the flexible metal straps 212, such that a portion of the thermoplastic resin of a surface of the thermoplastic composite sheet 10 opposite the flexible metal straps 212 adheres to the mold 110 or to a previously conformed thermoplastic composite sheet 10. The tacking step may be conducted at a temperature that exceeds the melting or softening temperature of the thermoplastic resin of the delamination arresting elements 16 but is below the melting temperature of the thermoplastic resin of the structural strips 12.

As yet another alternative, the automated tacking device may be incorporated into the apparatus 180 rather than the apparatus 200. The automated tacking device of the apparatus 180 may periodically heat discrete locations of the thermoplastic composite sheet 10 (and/or a previously deposited thermoplastic composite sheet) just before or just after the thermoplastic composite sheet 10 is conformed to the contour of the mold 110 by the roller 186, thereby causing adhesion at such discrete locations between the thermoplastic composite sheet 10 and the underlying mold 110 or previously deposited thermoplastic composite sheet. The automated tacking device may be any device known in the art to be capable of locally heating a thermoplastic material, such as a laser directed at discrete tacking locations.

The method 400 may further comprise the step of removing the electrical current from the plurality of flexible metal straps 212, thus allowing the flexible metal straps 212 to cool and subsequently allowing the thermoplastic resin to cool, reducing the tack between the flexible metal straps 212 and the thermoplastic composite sheet 10. The method 400 may further comprise the step of withdrawing the flexible metal straps 212 from engagement with the thermoplastic composite sheet 10 while the thermoplastic composite sheet 10 remains in a conformed condition adhered to the mold 110 or to a previously conformed thermoplastic composite sheet.

The method 400 may comprise a step of repeating the conforming step illustrated in block 410 and the tacking step illustrated in block 420 for each thermoplastic composite sheet 10 of the plurality of thermoplastic composite sheets as depicted in block 430.

The method 400 may comprise a step of consolidating the plurality of thermoplastic composite sheets to form a thermoplastic composite component as depicted in block 440. The consolidating step may comprise heating, melting, and applying pressure to at least a portion of the plurality of thermoplastic composite sheets. The consolidation step 440 may be performed by means of a consolidation apparatus such as apparatus 120 illustrated in FIGS. 8 and 9, which is the subject of a co-pending patent application having the same inventorship as the present application. The consolidation apparatus may perform a consolidation cycle after the deposition of every layer of thermoplastic composite sheet 10 or the consolidation cycle may be performed every few layers, such as 4, 8, or 12 layers. Alternatively, the consolidation step 440 may comprise vacuum bagging and autoclave fusing the plurality of thermoplastic composite sheets on the mold 110. Alternatively, the consolidation step 440 may comprise vacuum bagging and fusing the thermoplastic composite sheets on the mold 110 within an oven.

Although the invention has been described with reference to the preferred embodiment illustrated in the attached drawing figures, it is noted that equivalents may be employed and substitutions made herein without departing from the scope of the invention as recited in the claims.

1. A sheet material for use in the manufacture of a thermoplastic composite component, the sheet material comprising a plurality of parallel structural strips and a plurality of delamination arresting elements, wherein each structural strip comprises a thermoplastic prepreg, wherein each structural strip is independent of and unfused to adjacent structural strips, and wherein each structural strip is connected to at least one other structural strip by a delamination arresting element comprising a thermoplastic resin.

2. The sheet material of claim 1, wherein each delamination arresting element is oriented at a perpendicular or oblique angle with respect to the structural strips.

3. The sheet material of claim 2, wherein the plurality of delamination arresting elements comprises an amorphous thermoplastic resin.

4. The sheet material of claim 2, wherein the plurality of delamination arresting elements comprises a thermoplastic resin having a lower modulus than a thermoplastic resin of the structural strips.

5. The sheet material of claim 2, wherein the plurality of delamination arresting elements comprises a thermoplastic resin having a melting temperature lower than a melting temperature of a thermoplastic resin of the thermoplastic prepreg of the plurality of structural strips.

6. The sheet material of claim 2, wherein the plurality of delamination arresting elements is fused to the plurality of structural strips in at least some locations.

7. The sheet material of claim 2, wherein each delamination arresting elements passes under some structural strips and over other structural strips.

8. The sheet material of claim 2, wherein the thermoplastic prepreg comprises carbon fibers.

9. The sheet material of claim 2, wherein the structural strips have a width of between Smm and 20 mm, and a thickness of between 0.1 mm and 0.3 mm.

10.-15. (canceled)

16. A method of manufacturing a thermoplastic composite component from a plurality of thermoplastic composite sheets, wherein the thermoplastic composite sheets each comprise a plurality of parallel strips of thermoplastic prepreg, wherein each strip is independent of and unfused to adjacent strips, the method comprising:
conforming a thermoplastic composite sheet of the plurality of thermoplastic composite sheets to a contoured mold or to a previously conformed thermoplastic composite sheet, wherein the thermoplastic prepreg of at least some of the strips comprising the thermoplastic composite sheet is in a rigid state while the thermoplastic composite sheet is conformed;
tacking at least a portion of the thermoplastic composite sheet to the contoured mold or to a previously conformed thermoplastic composite sheet; repeating the conforming and tacking steps until all of the thermoplastic composite sheets of the plurality of thermoplastic composite sheets have been conformed and tacked together; and
melting and consolidating the plurality of thermoplastic composite sheets to form the thermoplastic composite component.

17. The method of claim 16 wherein the conforming step is performed manually.

18. The method of claim 16, wherein the conforming step and the tacking step are performed by means of an apparatus comprising a conforming device and a tacking device.

19. The method of claim 18, wherein the conforming device comprises a deformable roller.

20. The method of claim 18 wherein the conforming device comprises a plurality of flexible metal straps configured to contact the thermoplastic composite sheet, the method further comprising:
directing an electrical current through the plurality of flexible metal straps so as to create heat via the joule effect;
bringing the plurality of flexible metal straps into contact with the thermoplastic composite sheet so as to heat a portion of the thermoplastic resin of the thermoplastic composite sheet and cause the resin of the thermoplastic composite sheet to adhere to the plurality of flexible metal straps;
moving the plurality of flexible metal straps so as to bring the thermoplastic composite sheet into engagement with the contoured mold or with a previously conformed thermoplastic composite sheet.

21. The method of claim 20, wherein the tacking device comprises a plurality of flexible metal straps configured to contact the thermoplastic composite sheet, and wherein the tacking device may comprise the same flexible metal straps as the conforming device.

22. The method of claim 20, further comprising the step of removing the electrical current from the plurality of flexible metal straps and allowing the flexible metal straps to cool.

23. The method of claim 22, further comprising the step of withdrawing the plurality of flexible metal straps from engagement with the thermoplastic composite sheet while the thermoplastic composite sheet remains in a conformed condition.
